(19) United States
(12) Patent Application Publication
(10) Pub. No.: US 2023/0153810 A1
(43) Pub. Date: May 18, 2023

(54) SYSTEMS AND METHODS FOR AUTHENTICATING ELECTRONIC TRANSACTIONS AT VIRTUAL REALITY DEVICES USING MOBILE APP PAYMENT ACCOUNT(S)

(71) Applicant: Worldpay, LLC, Symmes Township, OH (US)

(72) Inventor: Charlotte SPENDER, Tonbridge (GB)

(21) Appl. No.: 18/155,941

(22) Filed: Jan. 18, 2023

Related U.S. Application Data
(63) Continuation of application No. 16/229,575, filed on Dec. 21, 2018.

(51) Int. Cl. G06Q 20/40; H04L 9/40; G06K 19/06

(52) U.S. Cl. CPC G06Q 20/40; H04L 63/0861; G06K 19/06037; G06F 3/011

(57) ABSTRACT

A method of authenticating payment transactions in virtual reality environments using user data includes receiving user registration with a payment application, the registration including stored user data; detecting a virtual reality device; linking the payment application to the virtual reality device; detecting an item selection for purchase in a virtual reality environment provided by the virtual reality device; and prompting payment authentication of the selected item in the virtual reality environment using the stored user data of the payment application.

### INTRODUCTION

Virtual reality (VR) works by connecting a specially designed headset to a device (e.g., a personal computer (PC) or mobile phone). The headset provides a head mounted display, which enables the user to view, experience, or interact with a virtual world and content while an application is running on the device. The headset may provide an virtual reality experience, where a user may be immersed in a virtual setting that provides options for a user to select and a virtual world for the user to explore through their selections.

Currently, to make a payment in VR, a user must first setup an account with payment credentials and a password to authenticate themselves in the VR platform or application. The user must then log-in to their account or remove the headset to log in, thus disrupting the immersive VR experience.

Existing approaches to authentication in VR environments may be limited to in-app purchases for games and may take the form of a platform-dependent digital gaming wallet. For example, a user may sign up for a platform-dependent digital gaming wallet, which then allows the user to make in-app purchases for any games hosted on that particular platform. Current wallets may be available only on a user's own device.

There is currently no secure way for an individual to store identity and payment credentials which they can later use in a public VR application. Accordingly, existing VR payment options do not work in a public virtual reality experience where (a) the VR experience may not be hosted on a gaming platform, and (b) the user does not own the PC or headset. As a result, a desire exists to permit individuals to securely and seamlessly pay for purchases in a public VR application.

### SUMMARY OF THE DISCLOSURE

According to certain aspects of the disclosure, systems and methods are disclosed for generating a virtual reality payment authentication entry interface.

In accordance with another embodiment, a system is disclosed for authenticating payment transactions in virtual reality environments using user data, the system comprising: a data storage device storing instructions for authenticating payment transactions in virtual reality environments using user data; and a processor configured to execute the instructions to perform a method including: receiving user registration with a payment application, the registration including stored user data; detecting a virtual reality device; linking the payment application to the virtual reality device; detecting an item selection for purchase in a virtual reality environment provided by the virtual reality device; and prompting payment authentication of the selected item in the virtual reality environment using the stored user data of the payment application.

In one embodiment, a computer-implemented method is disclosed for authenticating payment transactions in virtual reality environments using user data, the method comprising: receiving user registration with a payment application, the registration including stored user data; detecting a virtual reality device; linking the payment application to the virtual reality device; detecting an item selection for purchase in a virtual reality environment provided by the virtual reality device; and prompting payment authentication of the selected item in the virtual reality environment using the stored user data of the payment application.

In accordance with another embodiment, a non-transitory machine-readable medium storing instructions that, when executed by the server, causes the server to perform a method for authenticating payment transactions in virtual reality environments using user data, the method including: receiving user registration with a payment application, the registration including stored user data; detecting a virtual reality device; linking the payment application to the virtual reality device; detecting an item selection for purchase in a virtual reality environment provided by the virtual reality device; and prompting payment authentication of the selected item in the virtual reality environment using the stored user data of the payment application.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that a user may provide payment authentication credentials in a virtual reality environment, without having the credentials being detectable to an individual or observer in the same physical space as the user. The disclosed systems and methods discussed below may allow a user to securely enter their payment credentials in a VR environment. It is to be understood that both the foregoing general description and the following detailed description are exemplary and explanatory only and are not restrictive of the disclosed embodiments, as claimed.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a simplified block diagram of at least one embodiment of a system for authenticating payment transactions in virtual reality environments using user data from existing mobile app payment account(s);

FIG. 2 is a schematic diagram of at least one embodiment of a method for authenticating payment transactions in virtual reality environments using user data from existing mobile app payment account(s);

FIG. 3 is a simplified flow diagram of at least one embodiment of a method for authenticating payment transactions in virtual reality environments using user data from existing mobile app payment account(s);

FIG. 4 is a simplified flow diagram of at least another embodiment of a method for authenticating payment transactions between a mobile app, a server (or network), and a virtual reality platform; and

FIG. 5 depicts exemplary displays for a system authenticating payment transactions in public virtual reality environments, in accordance with at least one embodiment.

### DETAILED DESCRIPTION

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment can be combined with the features of other non-limiting embodiments. Such modifications and variations are intended to be included within the scope of the present disclosure.

For simplicity, the description that follows will be provided by reference to a “payment vehicle” or a “payment card,” which generally refers to any type of financial alternative to cash. As is to be clear to those skilled in the art, no aspect of the present disclosure is specifically limited to a specific type of payment vehicle or payment card. Therefore, it is intended that the following description encompasses the use of the present disclosure with many other forms of financial alternatives to cash, including credit cards, debit cards, smart cards, chip-based payment cards, single-use cards, prepaid cards, electronic currency (such as might be provided through a cellular telephone or personal digital assistant), and the like. Payment vehicles or payment cards can be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, prepaid or stored-value cards, electronic benefit transfer cards, a “virtual” card (e.g., in the form of a display on a smart phone), or any other like financial transaction instrument. In any event, the payment vehicles described herein communicate account information (e.g., an account number or other account indicative information) during a purchase event and/or payment or credit transaction.

The processing of electronic payment transactions typically involves a series of communications between many different entities, such as merchants, acquirer processors, payment networks, issuer processors, across a variety of networks. In a VR environment, a current user may not authenticate a payment unless they setup an account or have an account with a platform-dependent digital gaming wallet, which may be available only from the user's own device(s). Accordingly, the current setup does not work in a public virtual reality experience where the user may not have a preexisting payment account (with stored payment credentials), or wish to allow the VR platform direct access to their payment credentials. Alternately, a user must exit or interrupt the VR environment/experience to make a payment. As a result, a desire exists to permit individuals to securely and seamlessly pay for purchases in a public VR application.

As described in more detail below, the systems and methods described herein can provide users with platform-agnostic payment options that do not interrupt an immersive VR experience. Such systems and methods may be especially useful in public VR experiences, where users may not have payment authorization accounts with the public VR devices.

In particular, the disclosed systems and methods involve pairing a (public) virtual reality headset with a user's personal device to allow individual payment authentication in a public space or experience. In such a case, the virtual reality headset may be a public virtual reality headset that does not or cannot store, contain, or access the user's payment credentials (e.g., payment authorization information). Rather, the user's payment authorization information is securely stored by the user's personal device.

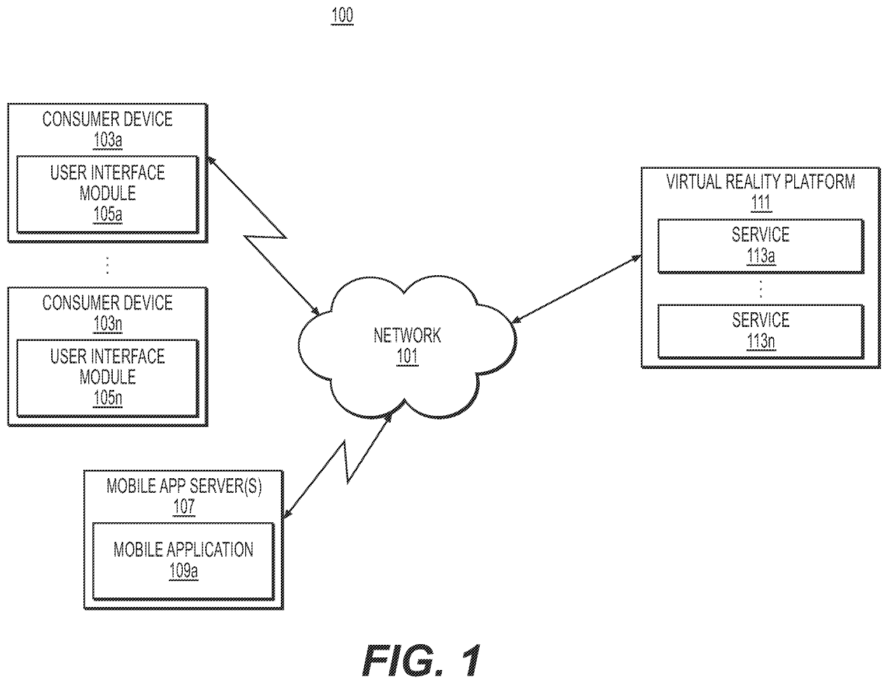

Referring now to FIG. 1, a block diagram is depicted of an exemplary environment 100 and network 101 for authenticating payment transactions in virtual reality environments using existing mobile app payment account(s), according to an exemplary embodiment of the present disclosure. Environment 100 may include a plurality of consumer devices 103a-103n operating user interface modules 105a-105n, mobile app server(s) 107 operating mobile application 109a, and a virtual reality platform 111 associated with services 113a-113n, and network 101. Consumer devices 103a-103n (or consumer devices 103) may include personal devices, e.g., phones, computers, laptops, mobile phones, tablet computers, watches, wearable devices, etc. Payment authentication may be collected via user interface modules 105a-105n (or user interface modules 105). For instance, payment authentication may involve biometric data. Biometric data of users may be collected via user interface modules 105a-105n, or via one or more cameras, microphones, fingerprint readers, retinal scan devices, or other biometric devices of each of the consumer devices 103.

In one embodiment, mobile application server(s) 107 may include or host mobile application 109a, which may include a payment application and/or biometric application. For example, mobile application 109a may be installed on consumer device 103a. Mobile application 109a may prompt a user to register with the mobile application 109a, which may entail prompting the user to submit biometric data, a personal identification number (PIN), or other secure code associated with the user. The user interface module 105a of consumer device 103a may receive biometric data, a PIN, or other secure code of the user and transmit the biometric data, the PIN, and/or the secure code to the mobile application 109a for future authentication of the user. The consumer device 103a and/or mobile application 109a may further encrypt or securely save the received biometric data to verify the identity of the user, for example, in payment transactions.

Virtual reality platform 111 may host one or more services 113a-113n (or services 113). The virtual reality platform 111 and services 113 may provide immersive VR experiences. In one embodiment, a consumer device 103 may be linked to a virtual reality platform service 113a via the virtual reality platform 111. The link may be initiated by Bluetooth, a Quick Response (QR) code, NFC tag, etc. and then maintained via secure tunnel (e. g., secure socket layer (“SSL”), virtual private network (“VPN”), etc.). In one embodiment, mobile application 109a may prompt various display(s) inside the VR experiences of services 113a-n. For example, mobile application 109a may prompt a service 113a to display a payment verification icon or graphic. The payment verification display may include a prompt to the user to submit biometric data or other secure code for payment to be verified, a graphic indicating successful completion of payment, or a graphic showing denial of payment or unsuccessful payment authorization.

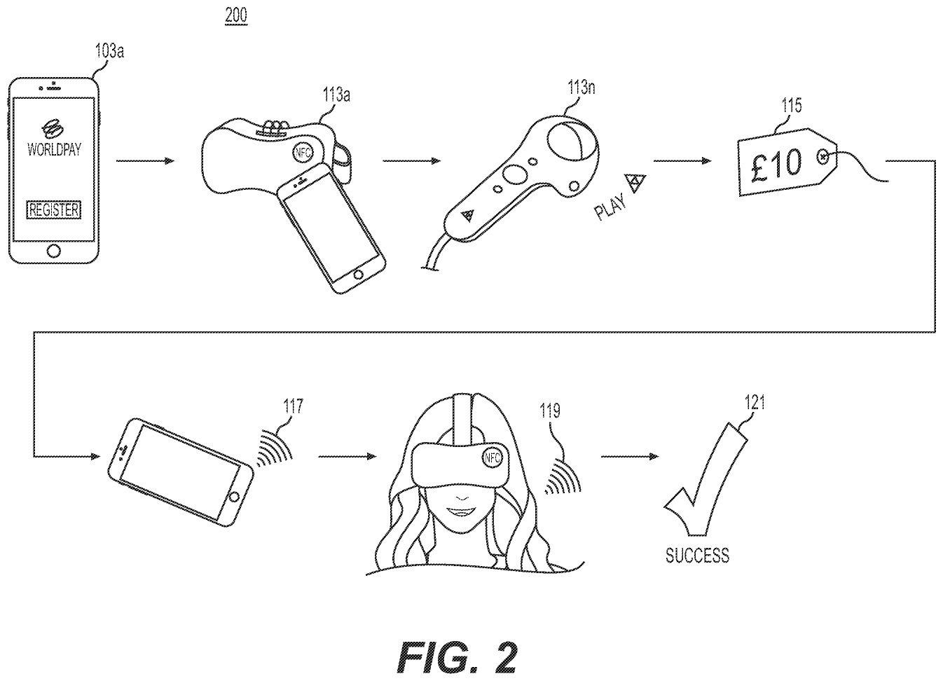

FIG. 2 depicts one embodiment of a public VR payments method 10 consistent with embodiments of the current disclosure. In such an embodiment, consumer device 103 may be a personal mobile device that may securely store a user's identity and payment credentials. For example, a user may securely store their identity and payment credentials on their own mobile device. The credentials and identity may be tokenized and stored by a third party service in communication with the consumer device 103 (e.g., via an installed mobile app, for instance, mobile application 109). In one scenario, the installed mobile app may request a user registration, which may prompt the user to enter payment credentials (e.g., a personal identification number (PIN), password, biometric data, contact information, payment vehicle data, answers to security questions, etc.).

Consumer device 103 may be linked to a virtual reality service 113a, e.g., a (public) VR headset. For example, a user may pair their personal consumer device 103 to a VR experience (e.g., via Bluetooth, a Quick Response (QR) code, NFC tag, etc.). The pairing may create a private, encrypted session between the user's personal consumer device 103 and the public VR experience of virtual reality service 113 (e.g., a VR headset). The current systems and methods may include detecting such a pairing of the user's device to a compatible VR experience. Once the personal consumer device 103 and virtual reality service 113 are linked, consumer device 103 may be stored securely on the user's person, in a pocket, in a bag etc. leaving the user free to interact with the VR experience.

The current systems and methods may detect a payment trigger 115 indicating the user's desire to make a purchase while the user is immersed in VR (e.g., via a virtual reality service 113a (for instance, a VR headset) and a virtual reality service 113n (for instance, a VR module). Payment trigger 115 may include, for instance, a voice command, gesture, eye movement, head movement, hand movement, body movement, button selection, etc. One such payment trigger 115 may include a user saying, “select tent model number 0503 for purchase.” Another payment trigger 115 may include a user nodding in response to an item being shown in their VR experience. In one embodiment, payment trigger 115 may initiate the mobile application of personal mobile device 13 to detect the user's selection of an item for purchase, e.g., via a VR headset, a VR module, any virtual reality service 113, a motion, gesture, vocal command, etc.

Prompt 117 may be generated and transmitted at or to a user interface module 105 of mobile device 13 in response to the payment trigger 115 (e.g., a detected motion from any virtual reality service 113, a VR module, a VR headset, a voice command, or other user input). In one embodiment, prompt 117 may include a prompt for the user to submit data to authenticate payment. For example, prompt 117 may request for the user to submit biometric data including a voice sample, fingerprint, gesture, secure code or PIN selection, etc. In one such case, prompt 117 may include requesting the user to respond to an auditory prompt, e.g., “You have selected a lantern to purchase for £10. Would you like to confirm payment by your Visa card?”

The user, while still immersed in the VR experience, may submit biometric data to confirm their payment (e.g., via voice command 119). For instance, voice command 119 may include a sample of the user's voice saying “yes, buy the lantern for £10 using my Visa card.” On receiving an affirmative response from the user, the personal consumer device 103 may authenticate the user's identity using, for example, the registered/stored biometric and the received user's biometric (e.g., the voice command 119). If the registered biometric data and the received biometric data match and the user is authenticated, payment may be processed on the user's behalf. Once payment is authenticated and complete, the mobile app of personal consumer device 103 may prompt a display of an icon 121 (e.g., within the VR experience of a VR headset) to acknowledge the payment.

Other embodiments may include a user submitting a PIN or other secure code while still in the VR (or augmented reality) environment. For example, a user may select alphanumeric symbols of their PIN/code based on VR or AR cues. The cues may involves audio, visual, or other sensory prompts that may permit a user to securely enter their PIN/code while in their VR or AR environment.

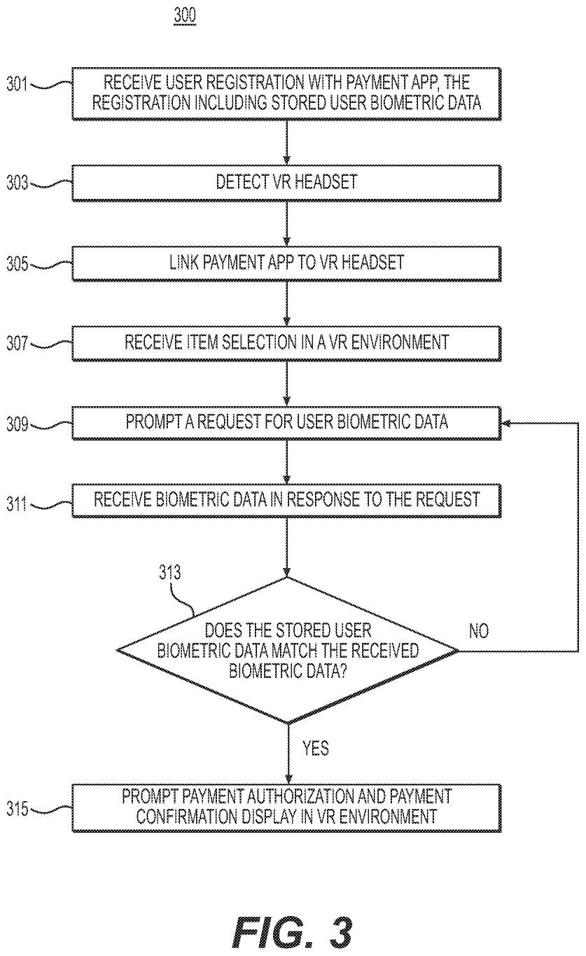

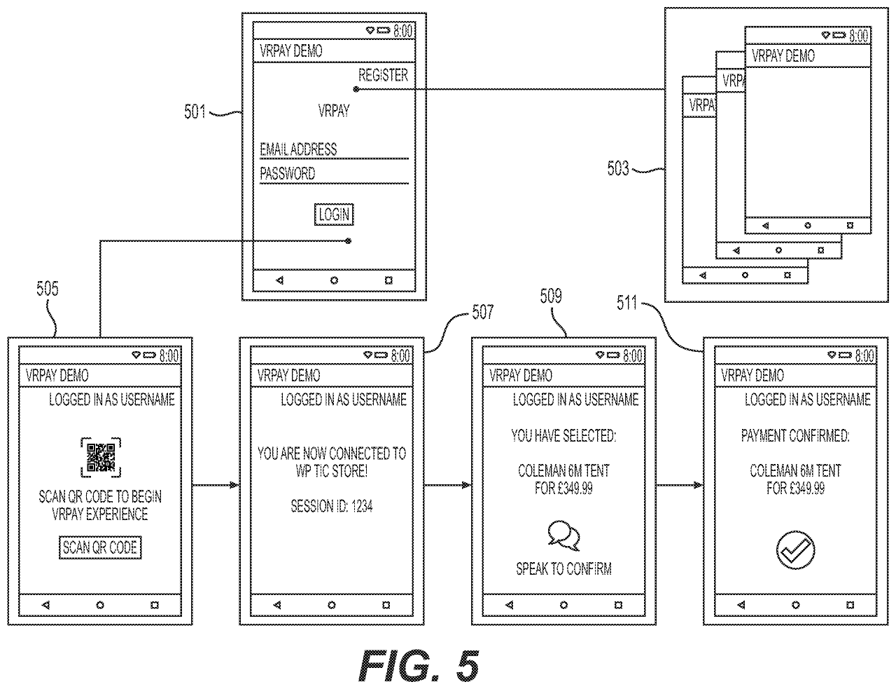

FIG. 3 is a flow diagram of an exemplary method 300 of authenticating payment transactions in virtual reality environments using biometric data, according to an exemplary embodiment of the present disclosure. In one embodiment, step 301 may include receiving user registration with a payment mobile application installed on a user's personal device (e.g., as shown in display 501 of FIG. 5). The user registration may include the user submitting and storing biometric data to the payment application and/or personal device. For example, the user may initiate an account set up with the payment application. The account setup may include a request for the user to enter/enroll payment information associated with one or more payment vehicles. Account setup may further include a request for a biometric data submission/enrollment from the user, e.g., a voice sample. For example, the user may be prompted to enroll payment credentials that include biometric data. Such payment credentials may include eye scan(s), fingerprint(s), voice sample recording(s), etc. Account setup may be in varying levels of complexity and take the user through one or more prompts for payment credentials, as shown by displays 503 of FIG. 5. For instance, displays 403 may prompt a user to setup two-step (or multiple-step) authentication and provide additional biometric or personal data for each step of the authentication. The payment app may convert the voice sample as a voiceprint, which may be used to authenticate the user's identity during payment. The registration at step 301 may further include tokenizing and storing such biometric data or voice print(s).

Steps 303 and 305 may include detecting a VR device (e.g., a VR headset) and linking the payment application (or user's personal device) to the VR headset. The linking of step 305 may be performed through Bluetooth, a QR code, an NFC tag, etc. For example, a public VR headset may provide a QR code. The QR code may be randomly generated by the VR service (e.g., service 113a) for each new user session. A user may open the payment app and scan the QR code provided by the VR experience, as shown by display 505 of FIG. 5. Step 305 may include receiving or detecting the QR code of the VR experience. Completion of step 305 may be paired with an indication (e.g., display 507 of FIG. 5) showing that the user's personal device and the VR device are linked.

Step 307 may include receiving an item selection from a VR environment provided by the VR headset. The item selection may come from a user selecting a virtual item of the VR environment using a gesture, button click, eye movement, oral/voice command, movement, etc. In one embodiment, step 307 may include prompting a display, on the user's personal device and/or the VR environment to indicate the user's selection. Exemplary display 509 of FIG. 5 is one such display that may comprise a user interface on the user's personal device and a corresponding display/graphic in the VR environment (not shown). The graphic in the VR environment showing the item selection may permit the user's immersive VR experience to be uninterrupted even as they are preparing to make a payment. In one embodiment, the VR environment may include a virtual retail experience, e.g., an outdoor setting simulating a campsite. Various items for purchase may be shown at the virtual campsite, and a user may select one or more of the virtual camping supplies shown in the VR campsite for purchase. Item selection may comprise a user input, e.g., a user gesturing to “grab” a camping supply and put it into a virtual “cart” or “box”, a user orally conveying key word (e.g., “purchase tent”, “buy tent”, etc.), nodding, etc.). In one embodiment, step 307 may further include prompting a user to confirm their selection.

Step 309 may include prompting a request for user payment credentials, where the payment credentials may include biometric data. For example, step 309 may include prompting the user to provide a vocal confirmation of the purchase shown in the graphic (e.g., corresponding to display 409). In one instance, step 309 may include an auditory prompt where a user may hear, “You have selected the 6M Tent for purchase for £349.99. Would you like to purchase the 6M Tent?” Step 311 may include receiving biometric data from the user as payment credentials to authenticate their identity for payment authorization. For example, step 311 may including receiving voice input comprising, “Yes, I would like to purchase the 6M Tent for £349.99. Confirm payment.”

In one embodiment, step 313 may include comparing the received biometric data from step 309 to the stored biometric data, and authenticating a user's identity based on the comparison. For example, if the received biometric data matches the enrolled biometric data, the user selecting the item in the VR environment may be confirmed as the user enrolled in the payment app. Payment using the user's enrolled payment vehicle(s) may then be authorized (e.g., step 315) and method 300 may proceed to prompting or providing a payment confirmation in the VR environment. Payment confirmation may take the form of a display (e.g., display 511 of FIG. 5), an auditory confirmation, or a combination thereof. If a match between the received biometric data and the enrolled biometric data is not obtained, a request for a resubmission of the previously requested biometric data (of step 309) may be displayed. Alternately or in addition, a request for additional biometric or user identification information or a screen denying purchase of the selected item may be provided or initiated, in response to a mismatch between the received biometric data and the enrolled biometric data.

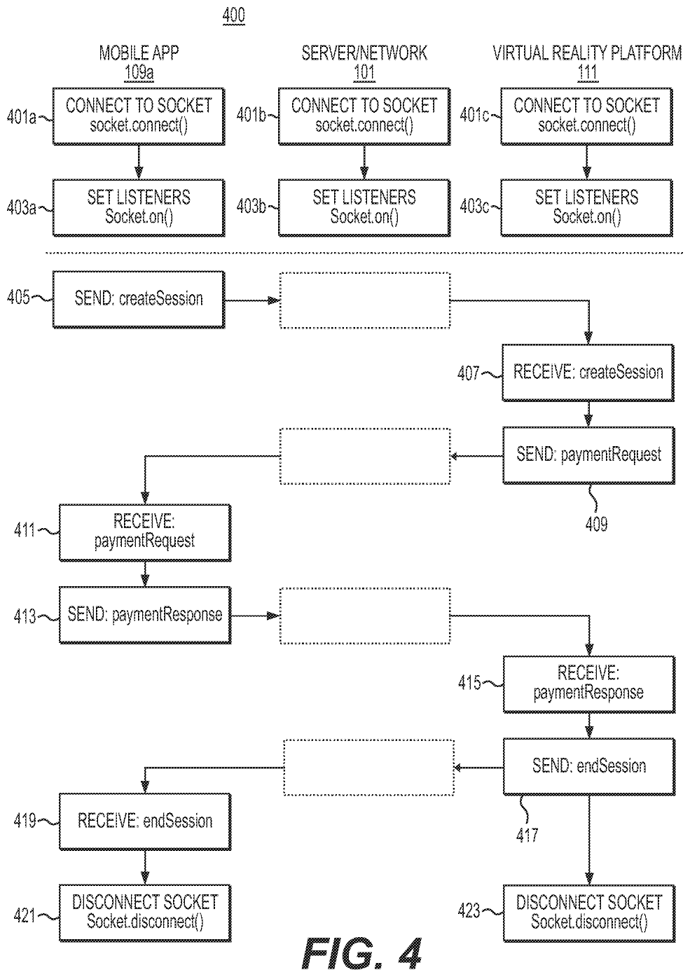

FIG. 4 is a flow diagram of a method 400 for authenticating payment transactions between a mobile app 109a, a server (or network 101), and virtual reality platform 111, according to an exemplary embodiment of the present disclosure. In one embodiment, method 300 may initiate once mobile app 109a (and its corresponding user/consumer device 103a) is linked to a VR platform 111. The linkage may be provided by a socket connection between the consumer device 103a and VR platform 111. In some cases, the socket may comprise a virtual socket/connection, e.g., initiated by a QR code scan. One embodiment may include each device connecting to a virtual socket (step 401) and setting listeners (step 403), e.g., sensors for user biometric or gesture input or electronic (e.g., smart) listeners, which may provide the respective device with the capability of communicating via a web socket. The virtual socket may comprise or include a web socket that provides secure data transmission between devices. In one scenario, if a device sets a listener for “createSession,” the listener will receive any messages sent via the socket which are associated or labeled with “createSession.” In one embodiment, other devices connected to the same web socket but not having the same listener set for “createSession” will not receive the same message.

In one embodiment, mobile app 109a may connect to a socket (via step 401a) and set its listeners (via step 403a). A server in communication with mobile app 109a and virtual platform 111 may also connect to the socket (as step 401b) and set its listeners (as step 403b). The socket connection between the mobile app 109a and the server may provide secure, bidirectional, low latency communication between the mobile app 109a and the server. The socket connection may be established, for example, via an HTTP request from the mobile app 109a to the server, and an acceptance response from the server to the mobile app 109a. For example, once the HTTP handshake is complete, the initial HTTP connection may be replaced by a socket connection between the mobile app 109a and the server. Use of sockets may reduce latency relative to traditional HTTP connections. Alternately or in addition, VR platform 111 may further connect to the socket acknowledging its communication with mobile app 109 (e.g., step 401c) and initiate data retrieval from its listeners (e.g., step 403c). In an embodiment where the listeners comprise electronic listeners, listeners may wait to receive a message of a pre-defined name. The device may then be programmed to respond to receiving the message with a pre-defined name.

Once the mobile app 109a, server (or network 101), and VR platform 111 are initialized to receive biometric data and communicate with each other, mobile app 109a may transmit a “create session” message to VR platform 111 to initiate a new/private session with the VR platform 111 (e.g., step 405). In one embodiment, authentication for biometrics and payments may occur on a user's personal device (e.g., rather than via a web socket.) In such a scenario, the user's device may send a message via the web socket to confirm a user's identity and/or payment success/failure. The VR platform 111 may receive the message from mobile app 109a (e.g., step 407) and create a new session. The message may be transferred through a server or network 101. As discussed in method 300, the session may include a retail environment, in which a user may select items for purchase. Once the VR platform 111 detects an item selected for purchase, VR platform 111 may send a payment request message to mobile app 109a (e.g., step 409). Mobile app 109a may receive the payment request from VR platform 111 (e.g., step 411) and collect biometric data from the user in response to the payment request. The biometric data may be collected from any of the listeners set at step 403a, step 403b, or 403c. In another embodiment, biometric authentication may take place on the user's personal device. A success or failure message may then be sent via listeners to the VR platform/experience.

Once biometric data is collected, mobile application 109a may authenticate the user's identity and authorize or decline payment as a response, respectively, to a match or mismatch between the collected biometric data and previously stored/enrolled user biometric data. The decision to authorize or decline payment may be conveyed from the mobile app 109a to the VR platform 111 in the form of a transmitted payment response message (e.g., step 413). Transaction decision may be conveyed securely via a virtual socket. The VR platform 111 may receive the payment response (e.g., step 415) and display a payment response graphic and/or auditory script in the VR environment. Another payment response or showing of payment success may include a reset of a virtual shopping cart/basket. The payment response graphic/script may be prompted and/or provided by the mobile app 109a.

The VR 111 may receive indication from a user that the user wishes to end the session. At that point, the VR platform 111 may send an end session message to mobile app 109a (e.g., step 417). The mobile app 109a may receive the end session message from the VR platform 111 (e.g., step 419) and disconnect the mobile app 109a (and stored user payment credentials) from the VR environment provided by VR platform 111. Messages between mobile app 109a and the VR platform 111 may be transmitted via server/network 101, including, e.g., the sending of a payment request message to mobile app 109a (step 409), the sending of the payment response message (step 413), and the sending of an end session message (step 417). The step of disconnecting may entail the mobile app 109a disconnecting from the socket (e.g., step 421) and the VR platform 111 disconnecting from the socket (e.g., step 423) to permit the VR platform 111 to host a VR session with the next user or provide a new VR session with the current user.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed herein should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods can be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and can be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead can be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics can be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions can be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

Some of the figures include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

1-20. (canceled)

21. A system for authenticating payment transactions in virtual reality environments using user data, the system comprising:
a data storage device storing instructions for authenticating payment transactions in virtual reality environments using the user data; and
a processor configured to execute the instructions to perform a method including:
receiving, by a payment mobile application installed on a mobile consumer device of a user, a user registration, the user registration including stored biometric data;
detecting, by the mobile consumer device, a virtual reality device;
establishing, by the mobile consumer device, a connection with the virtual reality device;
receiving, by the mobile consumer device, a user selection of an item for purchase in a virtual reality environment provided by the virtual reality device;
receiving, by the mobile consumer device from a virtual reality platform via a network, a payment request message for the purchase for the item, based on the user selection of the item;
generating, by the mobile consumer device, a prompt for the user to provide payment credentials, the payment credentials including biometric data;
receiving, by the mobile consumer device, the payment credentials from the user;
comparing, by the mobile consumer device, the stored biometric data with the biometric data received with the payment credentials;
determining, by the mobile consumer device, an authentication of the user based on comparing stored biometric data with the biometric data received with the payment credentials;
authorizing, by the mobile consumer device, the payment request message based on determining the user is authenticated; and
transmitting, by the mobile consumer device to the virtual reality platform via the network, a payment response message for the purchase of the item.

22. The system of claim 21, wherein the virtual reality device cannot store, contain, or access the user registration.

23. The system of claim 21, wherein the processor is further configured for:
based on determining the user is not authenticated, generating a second prompt for the user to provide payment credentials.

24. The system of claim 21, wherein the processor is further configured for:
pairing the mobile consumer device with the virtual reality device.

25. The system of claim 21, wherein the processor is further configured for:
pairing the mobile consumer device with the virtual reality device via Bluetooth.

26. The system of claim 24, wherein the processor is further configured for:
pairing the mobile consumer device with the virtual reality device via a Quick Response (QR) Code.

27. The system of claim 24, wherein the processor is further configured for:
pairing the mobile consumer device with the virtual reality device via a Near Field Communication (NFC) tag.

28. The system of claim 24, wherein the processor is further configured for:
generating a private session between the mobile consumer device and the virtual reality device, and
generating a user interface or icon in the virtual reality environment based on another prompt from the payment application or the mobile consumer device.

29. A computer-implemented method of authenticating payment transactions in virtual reality environments using user data, the method comprising:
receiving, by a payment mobile application installed on a mobile consumer device of a user, a user registration, the user registration including stored biometric data;
detecting, by the mobile consumer device, a virtual reality device;
establishing, by the mobile consumer device, a connection with the virtual reality device;
receiving, by the mobile consumer device, a user selection of an item for purchase in a virtual reality environment provided by the virtual reality device;
receiving, by the mobile consumer device from a virtual reality platform via a network, a payment request message for the purchase for the item, based on the user selection of the item;
generating, by the mobile consumer device, a prompt for the user to provide payment credentials, the payment credentials including biometric data;
receiving, by the mobile consumer device, the payment credentials from the user;
comparing, by the mobile consumer device, the stored biometric data with the biometric data received with the payment credentials;
determining, by the mobile consumer device, an authentication of the user based on comparing stored biometric data with the biometric data received with the payment credentials;
authorizing, by the mobile consumer device, the payment request message based on determining the user is authenticated; and
transmitting, by the mobile consumer device to the virtual reality platform via the network, a payment response message for the purchase of the item.

30. The computer-implemented method of claim 29, wherein the virtual reality device cannot store, contain, or access the user registration.

31. The computer-implemented method of claim 29, further comprising:
based on determining the user is not authenticated, generating a second prompt for the user to provide payment credentials.

32. The computer-implemented method of claim 29, further comprising:
pairing the mobile consumer device with the virtual reality device.

33. The computer-implemented method of claim 29, further comprising:
pairing the mobile consumer device with the virtual reality device via Bluetooth.

34. The computer-implemented method of claim 32, further comprising:
pairing the mobile consumer device with the virtual reality device via a Quick Response (QR) Code.

35. The computer-implemented method of claim 32, further comprising:
pairing the mobile consumer device with the virtual reality device via a Near Field Communication (NFC) tag.

36. The computer-implemented method of claim 35, further comprising:
generating a private session between the mobile consumer device and the virtual reality device, and
generating a user interface or icon in the virtual reality environment based on another prompt from the payment application or the mobile consumer device.

37. A non-transitory machine-readable medium storing instructions that, when executed by a server, cause the server to perform a method for authenticating payment transactions in virtual reality environments using user data, the method including:
receiving, by a payment mobile application installed on a mobile consumer device of a user, a user registration, the user registration including stored biometric data;
detecting, by the mobile consumer device, a virtual reality device;
establishing, by the mobile consumer device, a connection with the virtual reality device;
receiving, by the mobile consumer device, a user selection of an item for purchase in a virtual reality environment provided by the virtual reality device;
receiving, by the mobile consumer device from a virtual reality platform via a network, a payment request message for the purchase for the item, based on the user selection of the item;
generating, by the mobile consumer device, a prompt for the user to provide payment credentials, the payment credentials including biometric data;
receiving, by the mobile consumer device, the payment credentials from the user;
comparing, by the mobile consumer device, the stored biometric data with the biometric data received with the payment credentials;
determining, by the mobile consumer device, an authentication of the user based on comparing stored biometric data with the biometric data received with the payment credentials;
authorizing, by the mobile consumer device, the payment request message based on determining the user is authenticated; and
transmitting, by the mobile consumer device to the virtual reality platform via the network, a payment response message for the purchase of the item.

38. The non-transitory machine-readable medium of claim 37, wherein the virtual reality device cannot store, contain, or access the user registration.

39. The non-transitory machine-readable medium of claim 37, further configured to cause the server to perform a method comprising:
based on determining the user is not authenticated, generating a second prompt for the user to provide payment credentials.

40. The non-transitory machine-readable medium of claim 37, further configured to cause the server to perform a method comprising:
pairing the mobile consumer device with the virtual reality device.
